(19) United States
(12) Patent Application Publication
(10) Pub. No.: US 2008/0020365 A1
(43) Pub. Date: Jan. 24, 2008

(54) Learning Apparatus Using Toy, And Control Method Thereof

(75) Inventors: Dong-Hoon Shin, Seoul (KR); Il-ku Kang, Gyeonggi-do (KR); Soon-Hyun Kwon, Gyeonggi-do (KR); Jin-Hyuk Choi, Gyeonggi-do (KR)

Correspondence Address: THE WEBB LAW FIRM, P.C., 700 KOPPERS BUILDING, 436 SEVENTH AVENUE, PITTSBURGH, PA, 15219, US

(73) Assignee: Bizkiz Corp., Seocho-gu (KR)

(21) Appl. No.: 11/597,298

(22) PCT Filed: May 26, 2005
(86) PCT No.: PCT/KR05/01554

§ 371 Date: Nov. 22, 2006

(30) Foreign Application Priority Data
May 27, 2004 (KR) 10-2004-0037697

(51) Int. Cl. G09B 5/06

(52) U.S. Cl. 434/322

(57) ABSTRACT

A toy type learning device and a method of controlling the toy type learning device are disclosed. A toy type input unit outputs a contents request signal in response to a user's key operation. A remote control unit converts the contents request signal into a wireless signal and outputs the wireless signal to a processing unit having a plurality of contents to request a corresponding content. Thus, the toy type learning device and a controlling method of the toy type learning device may extract the corresponding contents in response to the user's key operation and control an output of a multimedia, so that the toy type learning device may be used as a learning assistant for infants or children.

### TECHNICAL FIELD

The present invention relates to a toy type learning device and a method of controlling the same. More particularly, the present invention relates to a toy type learning device capable of controlling an output of a multimedia and method of controlling the toy type learning device.

### BACKGROUND ART

In accordance with development of electronics, various electrical instruments for educating infants and children have been manufactured. Especially, since a learning device provides the infants and the children with the learning contents using an audiovisual function based on the electronics, the learning device develops intelligence of the infants and the children, such as imagination, numerability, speech, creativity, color sense, morality, sociality, etc.

In order to educate the infants and the children using conventional aids such as a book, the infants and the children need one-one education contacts because the infants and the children cannot fluently understand contents such as a language derived from the conventional aids.

Moreover, the infants and the children do not tend to spontaneously and actively enter the learning in case of a video kit and concentrate on the learning in case of a conventional educational software for a computer.

### DISCLOSURE OF THE INVENTION

Technical Problem

The present invention provides a toy type learning device capable of controlling an output of a multimedia by operating a toy.

The present invention also provides a method of controlling the above toy type learning device.

Technical Solution

A toy type learning device in accordance with an aspect of the present invention includes a toy type input unit for outputting a contents request signal in response to a user's key operation, and a remote control unit for converting the contents request signal into a wireless signal and outputting the wireless signal to a processing unit having a plurality of contents to request a corresponding content.

A toy type learning device in accordance with another aspect of the present invention includes a toy type input unit for outputting a contents request signal in response to a user's key operation, a remote control unit for converting the contents request signal into a wireless signal and outputting the wireless signal, a processing unit for receiving a contents media and extracting one of a plurality of contents stored in the contents media in response to the wireless signal, and an output device for outputting the contents provided from the processing unit.

In a method of controlling a toy type learning device outputting contents corresponding to a user's key operation through an output device, the method in accordance with an aspect of the present invention is provided as follows. The user's key operation with respect to the toy is sensed, and a contents request signal is outputted. The contents request signal is converted into a wireless signal, and the wireless signal is outputted. One of the contents stored in a contents media is extracted in response to the wireless signal, and the extracted contents are outputted to the output device.

Therefore, the toy type learning device and the controlling method of the toy type learning device may extract the corresponding contents in response to the user's key operation and control an output of a multimedia, so that the toy type learning device may be used as a learning assistant for infants or children.

### BRIEF DESCRIPTION OF THE DRAWINGS

The above and other advantages of the present invention will become more apparent by describing in detail exemplary embodiments thereof with reference to the accompanying drawings, in which:

FIG. 1 is a block diagram illustrating a toy type learning device according to a first embodiment of the present invention;

FIG. 2 is a showing a toy type learning device according to the first embodiment of the present invention;

FIG. 3 is a view illustrating a toy type input unit shown in FIG. 1;

FIGS. 4 and 5 are block diagrams showing a remote control unit setting part shown in FIG. 1;

FIGS. 6 and 7 are flowcharts illustrating an operation of a remote control unit setting part shown in FIG. 1;

FIGS. 8 and 9 are views illustrating the remote control unit shown in FIG. 1;

FIG. 10 is a block diagram illustrating the second control part of the remote control unit and the toy type input unit;

FIG. 11 is a flowchart illustrating a program programmed in the second control part for the remote control unit;

FIGS. 12 to 14 are views illustrating a menu selection of the toy type learning device;

FIGS. 15 and 16 are views illustrating the menu selection of the toy type learning device according to another embodiment of the present invention;

FIG. 17 is a block diagram illustrating a method of controlling the remote control unit with an internet;

FIG. 18 is a block diagram illustrating a method of controlling the remote control unit with a compact disc;

FIG. 19 is a block diagram illustrating a toy type learning device according to a second embodiment of the present invention;

FIG. 20 is a view showing a toy type learning device according to the second embodiment of the present invention;

FIG. 21 is a block diagram illustrating a toy type learning device according to a third embodiment of the present invention;

FIG. 22 is a view showing a toy type learning device according to the third embodiment of the present invention;

FIG. 23 is a view illustrating a toy type input unit shown in FIG. 22; and

FIG. 24 is a view illustrating a signal relay part shown in FIG. 22.

### BEST MODE FOR CARRYING OUT THE INVENTION

It should be understood that the exemplary embodiments of the present invention described below may be varied modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings.

### First Embodiment

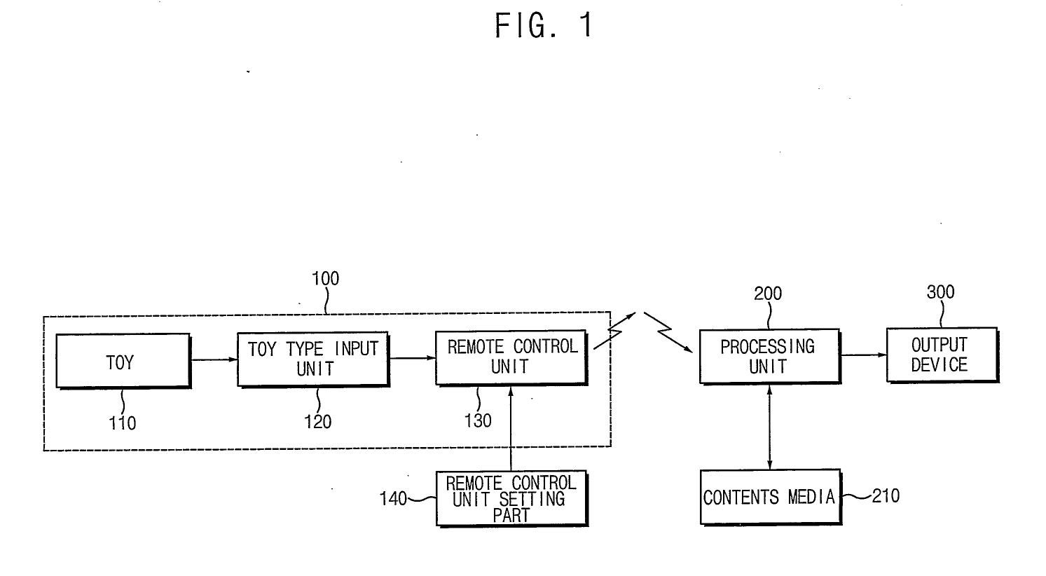

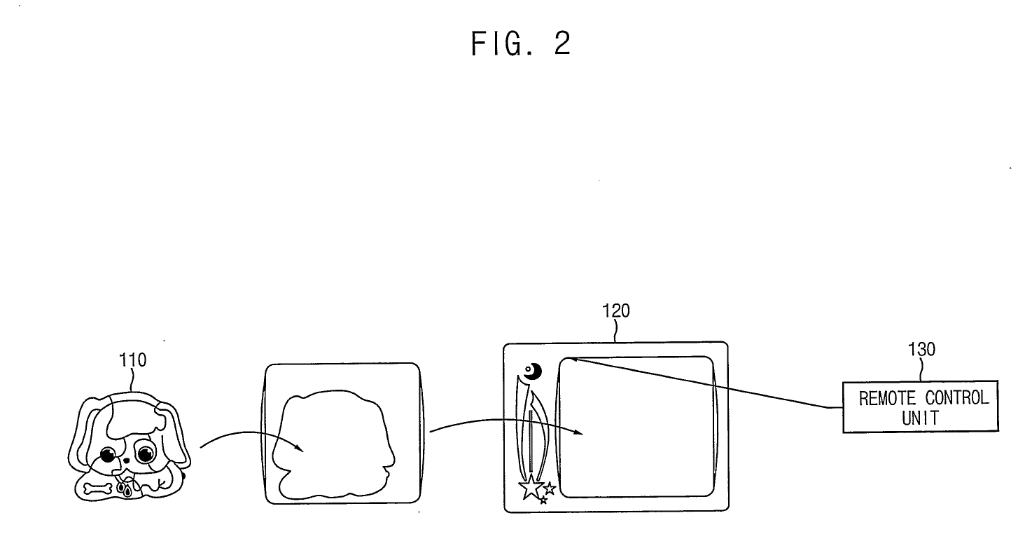

FIG. 1 is a block diagram illustrating a toy type learning device according to a first embodiment of the present invention. FIG. 2 is a showing a toy type learning device according to the first embodiment of the present invention.

As shown in FIGS. 1 and 2, a toy type learning device according to a first embodiment of the present invention includes a first toy body part 100, a processing unit 200 and an output device 300.

The first toy body part 100 includes a toy 110, a toy type input unit 120 and a remote control unit 130. The first toy body part 100 outputs a selection signal for selecting content to a processing unit 200. The remote control unit 130 may be attached to and detached from the first toy body part 100 and controlled by the remote control unit setting part 140.

As a puzzle tool, the toy 110 may include a plurality of puzzles. The toy 110 may be received in the toy type input unit 120 such that the toy 110 is easily attached to and detached from the toy type input unit 120.

For example, when an infant inserts the puzzles into a puzzle board, an audio data such as “You did a good job.” is outputted through the output device 300, or a video data is displayed on the output device 300 with the audio data such as “You are wrong. Please do it like this”, so that the infant may correctly insert the puzzle into the puzzle board.

That is, when the audio data or the video data those that may lead the infant to insert the puzzle into the puzzle board are outputted through the output device 300 and the infant inserts the puzzle into the puzzle board, the audio data such as “You did a good job” and “You are wrong” may be outputted through the output device 300, or the video data allowing the infant to correctly insert the puzzle into the puzzle board may be displayed on the output device 300 with the audio data such as “Please do it like this”.

The toy type input unit 120 receives the toy 110 and senses a status of the toy 110 being received in the toy type input unit 120. When the toy 110 is received in the toy type input unit 120, the toy type input unit 120 provides the remote control unit 130 with a toy insertion signal.

The remote control unit 130 is connected to the remote control unit setting part 140. The remote control unit 130 is attachable to and detachable from the remote control unit setting part 140. The remote control unit 130 provides signals corresponding to the processing unit 200 such as a digital video disc (DVD) player and adjusts an interval between the signals. The remote control unit 130 is controlled by the remote control unit setting part 140. The remote control unit 130 receives the toy insertion signal from the toy type input unit 120 and transmits a contents request signal corresponding to the toy insertion signal to the processing unit 200 in a wireless manner.

The processing unit 200 is connected to the first toy body part 100 in the wireless manner and receives a media 210 in which the contents are recorded. The processing unit 200 reads the recorded contents from the media 210 and provides the output device 300 with the read contents in response to a contents request signal. In the present embodiment, the processing unit 200 is a home appliance such as the DVD player. When the DVD player in which the contents may be recorded, software corresponding to the contents may be easily programmed. Thus, although a new processing unit 200 is not manufactured separately, the DVD player may use the contents.

The output device 300 provides a user such as the infant, the child, etc., with corresponding contents in a video mode or an audio mode while the read contents are supplied through the processing unit 200. The output device 300 includes a television or a home theater that may output the audio data and the video data.

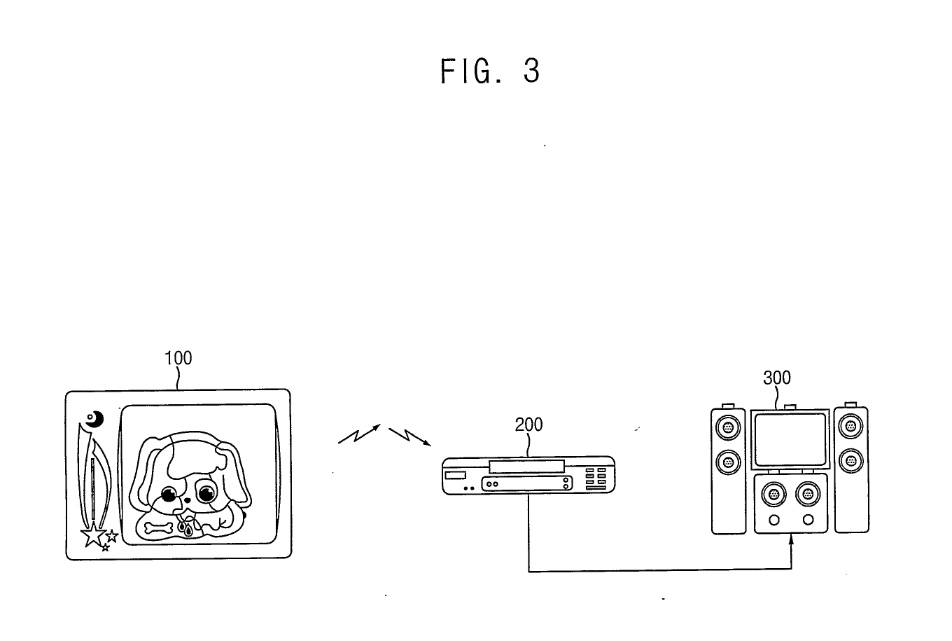

FIG. 3 is a view illustrating a toy type input unit shown in FIG. 1.

Referring to FIG. 3, the toy type input unit 120 according to a first embodiment of the present invention includes a toy connecting part 122, a switching part 124 and a first remote control unit connecting part 126.

The toy connecting part 122 performs a role as an interface connecting the toy 110 and the remote control unit 130. The toy 110 includes the contents such as the puzzles and a user interface for the contents.

The switching part 124 includes a toy insertion sensing sensor 124a sensing the insertion of the toy 110 and a contents request button 124b outputting a contents request signal in response to a user's operation. When the toy 110 is inserted into the toy type input unit 120, the switching part 124 generates the contents request signal, and the contents request signal is outputted from the remote control unit 130 through the first remote control unit connecting part 126.

In the present embodiment, the toy type learning device having the toy insertion sensing sensor 124a and the contents request button 124b to request the contents corresponding to the toy 110 has been described, but the contents request button 124b may be removed from the toy type learning device in case that the contents are requested by the toy insertion operation.

The switching device 124 may include various switching devices such as a conventional switching device and a switching device having a sensor in accordance with a kind of toy.

When a product configured by only the toy 110 and the media 210 may perform the contents request operation, the user may save money because manufacturing cost of the toy type learning device decreases.

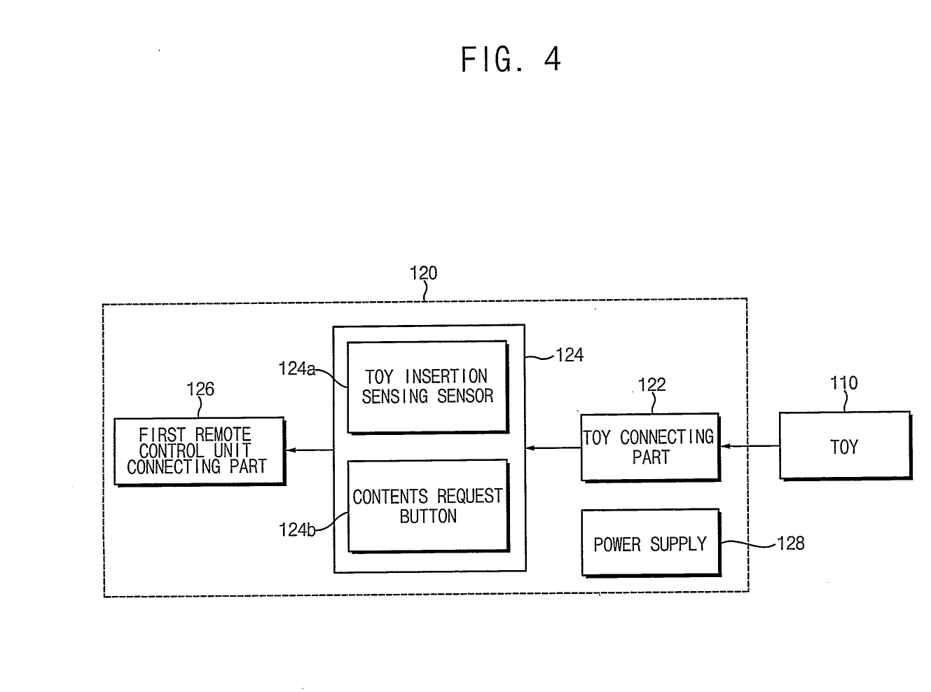

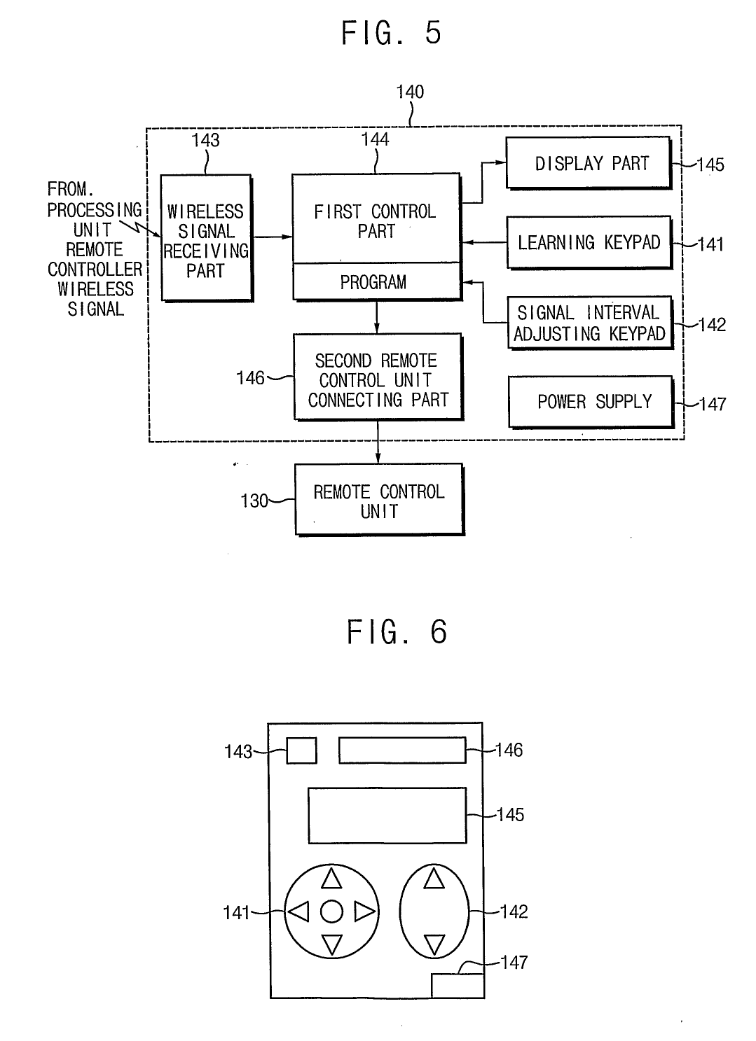

FIGS. 4 and 5 are block diagrams showing a remote control unit setting part shown in FIG. 1. FIG. 4 shows a block diagram of a remote control unit setting part, and FIG. 5 shows an outside of the remote control unit setting part.

As shown in FIG. 4, the remote control unit setting part 140 according to a first embodiment of the present invention includes a learning keypad 141, a signal interval adjusting keypad 142, a wireless signal receiving part 143, a first control part 144, a display part 145, a second remote control unit connecting part 146 and a power supply 147.

The learning keypad 141 includes an up key, a down key, a left key, a right key and an enter key and provides the first control part 144 with a button signal corresponding to a button pushed by the user. The signal interval adjusting keypad 142 includes a signal interval increase button and a signal interval decrease button and provides the first control part 144 with a signal value adjusted by the user.

The reason that key values for the up key, the down key, the left key, the right key and the enter key are set is because signals (code table index) from a remote controller required by the processing unit 200 are different from each other. That is, a remote control signal of a DVD player manufactured by SAMSUNG ELECTRONICS CO., LTD., a remote control signal of a DVD player manufactured by LG ELECTRONICS CO., LTD. and a remote control signal of a DVD player manufactured by SONY CO., LTD. are different from each other, so that the button signal corresponding to the remote control signals is set.

The remote control signals have a different time interval in accordance with the processing unit 200, so that the time interval of the remote control signals is adjusted by the signal interval adjusting keypad 142. That is, a remote control signal of a DVD player manufactured by SAMSUNG ELECTRONICS CO., LTD., a remote control signal of a DVD player manufactured by LG ELECTRONICS CO., LTD. and a remote control signal of a DVD player manufactured by SONY CO., LTD. have a different signal interval from each other, so that the signal interval is adjusted by the signal interval adjusting keypad 142.

The wireless signal receiving part 143 receives a signal from the processing unit 200 and provides the first control part 144 with the received signal from the processing unit 200.

The first control part 144 receives the input values inputted through the learning keypad 141 and the signal applied from the wireless signal receiving part 143, and stores the input values and the signal in the memory 134 of the remote control unit 130. The first control part 144 adjusts the signal interval in response to the input values from the signal interval adjusting keypad 142 and stores the adjusted signal in the memory 134 of the remote control unit 130. The first control part 144 provides the display part 145 with information indicating that the input values and the signal are completely stored and information inducing key input of the learning keypad 141.

The second remote control unit connecting part 146 performs a role of an interface to connect the remote control unit 130 and the remote control unit setting part 140.

The power supply 147 supplies a power voltage to the learning keypad 141, the signal interval adjusting keypad 142, the wireless signal receiving part 143, the first control part 144 and the display part 145.

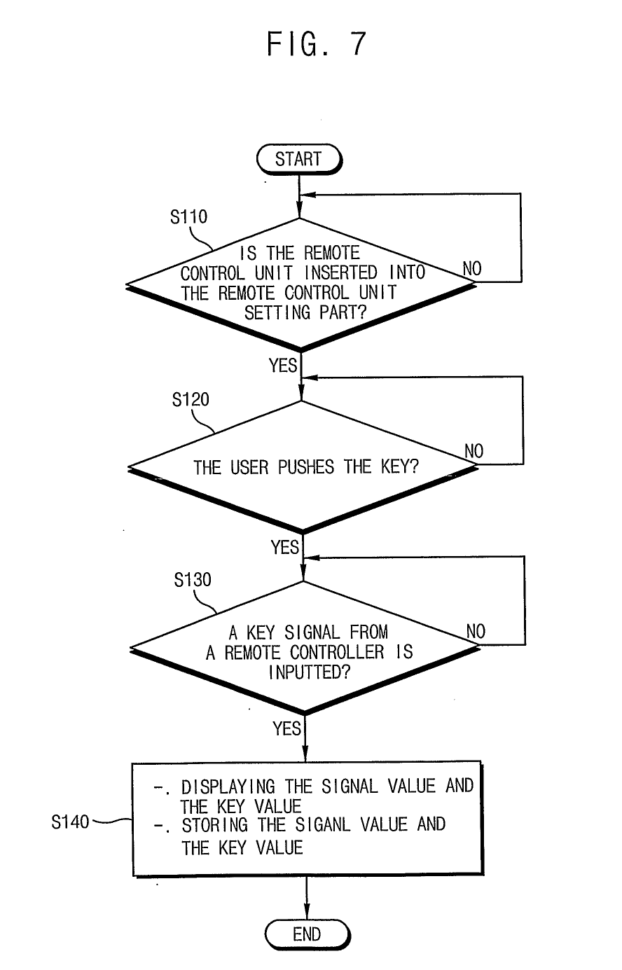

FIGS. 6 and 7 are flowcharts illustrating an operation of a remote control unit setting part 140 shown in FIG. 1. FIG. 6 is a flowchart illustrating a learning operation of the first control part 144 for the remote control unit, and FIG. 7 is a flowchart illustrating a learning operation for the remote control unit when intervals of the key values are adjusted.

Referring to FIGS. 1 to 6, in order to control the remote control unit 130, the first control part 144 checks whether or not the remote control unit 130 is inserted into the remote control unit setting part 140 (step Si lo). In step S 110, when the remote control unit 130 is inserted into the remote control unit setting part 140, the first control part 144 checks whether or not the user pushes the key (step S120).

In step S120, when the user pushes the key, the first control part 144 checks whether or not a key signal generated by a remote controller corresponding to the processing unit 200 is inputted (step S130).

In step S130, when the key signal is inputted, the first control part 144 provides the display device 145 with a signal value of the key signal from the remote controller corresponding to the processing unit 200 and a key value from the learning keypad 141 of the remote control unit setting part 140 by the user and stores the signal value and the key value in the memory 134 (step S140).

After controlled the remote control unit 130, a process of the flowchart shown in FIG. 7 in case of adjusting the signal interval between the signal values of the key signals is carried out.

As shown in FIG. 7, in order to control the remote control unit 130, the first control part 144 checks whether or not the remote control unit 130 is inserted into the remote control unit setting part 140 (step S210).

In step S210, when the remote control unit 130 is inserted into the remote control unit setting part 140, the first control part 144 checks whether or not the user pushes a speed adjust key (step S220).

In step S220, when the user pushes the speed adjust key, the first control part 144 provides the display device 145 with a speed adjust key value and stores the speed adjust key value in the memory 134 of the remote control unit 130 through the second remote control unit setting part 146 (step S230).

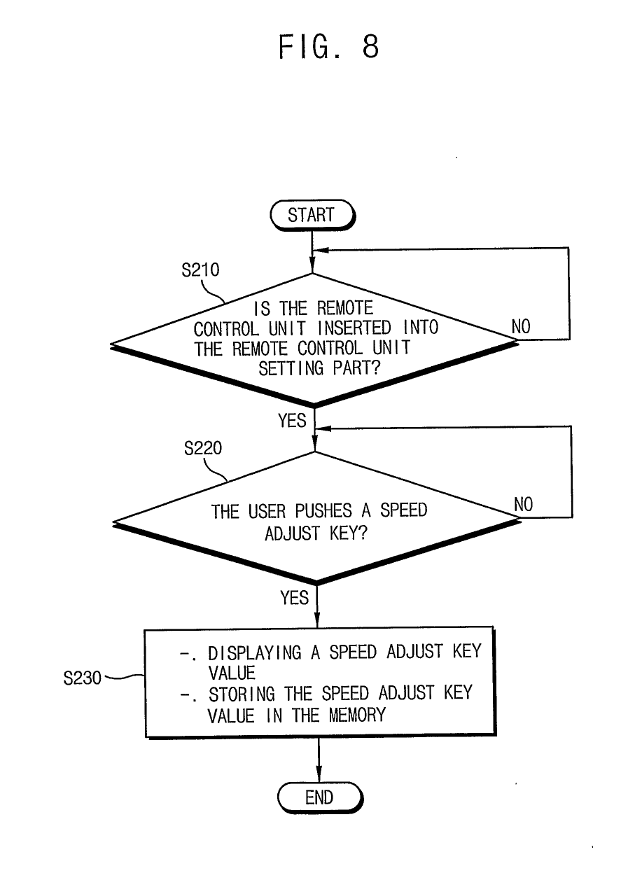

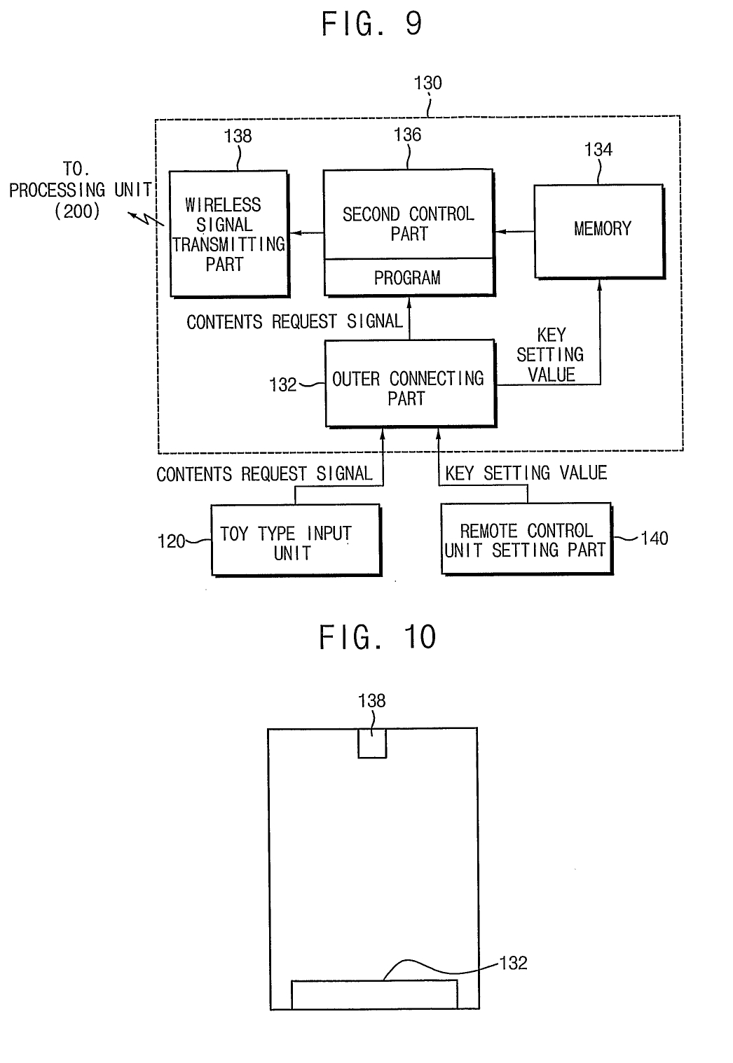

FIGS. 8 and 9 are views illustrating the remote control unit shown in FIG. 1. FIG. 8 shows a block diagram showing the remote control unit, and FIG. 9 shows an outside of the remote control unit.

As shown in FIG. 8, the remote control unit 130 according to a first embodiment includes an outer connecting part 132, the memory 134, a second control part 136 and a wireless signal transmitting part 138.

The outer connecting part 132 is connected to the toy type input unit 120 or the remote control unit setting part 140 to receive data. That is, when the outer connecting part 132 is connected to the toy type input unit 120, the outer connecting part 132 provides the second control part 136 with the contents request signal. When the outer connecting part 132 is connected to the remote control unit setting part 140, the outer connecting part 132 transmits a predetermined learning key value and a predetermined signal interval adjust value in the memory 134.

The memory 134 stores the predetermined learning key value and the predetermined signal interval adjust value provided through the outer connecting part 132.

The second control part 136 operates the contents request signal inputted through the toy type input unit 120 and the key value stored in the memory 134 using a program installed therein and outputs the operated data through the wireless signal transmitting part 138.

The wireless signal transmitting part 138 receives the operated data from the second control part 136 and converts the operated data into a wireless signal to provide the processing unit 200 with the wireless signal.

FIG. 10 is a block diagram illustrating the second control part of the remote control unit and the toy type input unit.

As shown in FIG. 10, the switching part 124 and the power supply 128 according to the first embodiment of the present invention are mounted on the toy type input unit 120, and the second control part 136 and the wireless signal transmitting part 138 are mounted on the remote control unit 130.

The switching part 124 may include a plurality of switches capable of being arranged in a matrix configuration, and numbers of the switches are determined according to a standard of a corresponding media.

In case that the contents request signal is provided from the switching part 124, a repeat function is not used when a switching operation is maintained without the contents request signal being provided for about two seconds. The switching part 124 may further include a contents request button 124b in consideration of a kind of the toy type input unit 120.

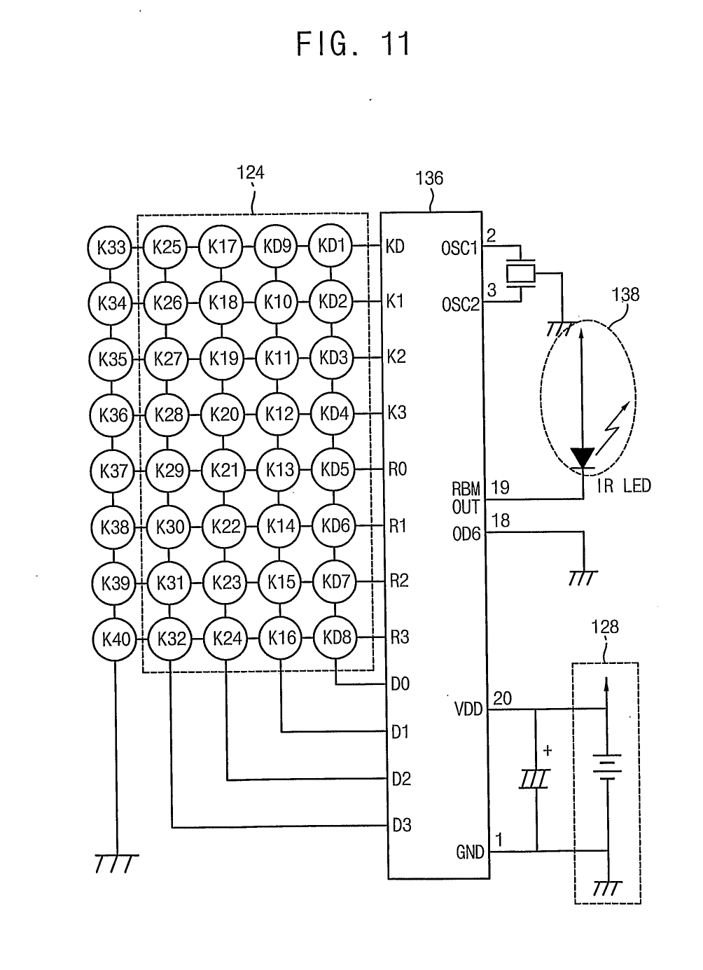

FIG. 11 is a flowchart illustrating the remote control unit. Particularly, in FIG. 11, a program programmed in the second control part 136 will be described.

Referring to FIG. 11, the second control part 136 checks whether or not the contents request signal generated by the toy type input unit 120 is received through the outer connecting part 132 (step S310).

In step S310, when the contents request signal is received, the second control part 136 extracts the key value from the memory 134 and the interval data from the memory 134 (step S320).

The second control part 136 generates a signal corresponding to a predetermined look-up table using the contents request signal, the key value and the interval data (step S340), and the second control part 136 transmits the generated signal to the process unit 200 through the wireless signal transmitting part 138. The transmitted signal through the wireless signal transmitting part 138 may be one signal or a plurality of signals that is sequentially transmitted through the wireless signal transmitting part 138.

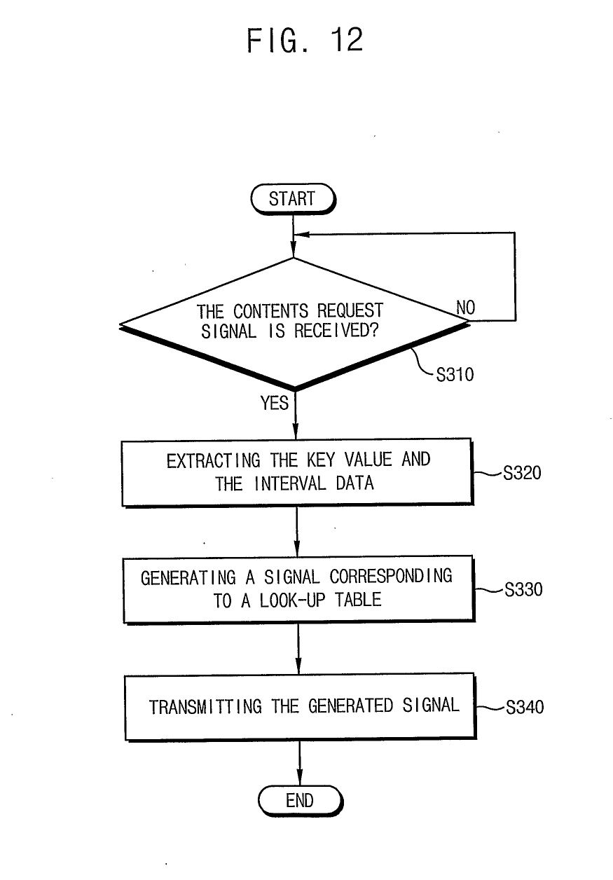

Hereinafter, a method of generating the signal corresponding to the predetermined look-up table will be described with reference to FIGS. 12 to 14.

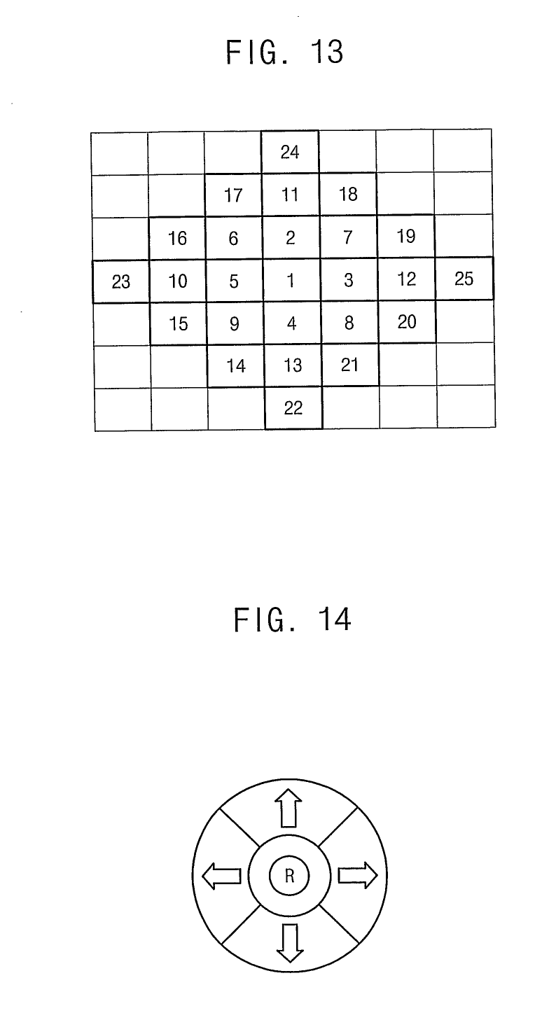

FIGS. 12 to 14 are views illustrating a menu selection of the toy type learning device. Particularly, FIG. 12 is a view illustrating a hidden menu of the contents media, FIG. 13 is a view illustrating a conventional key selection button, and FIG. 14 is a look-up table illustrating a signal sequence corresponding to contents number.

As shown in FIG. 12, the hidden menu according to the present invention includes indexes corresponding to 25 contents and the indexes are arranged in a matrix configuration. Particularly, when an imaginary center portion is defined as a key value of “1” and numbers of toys gradually increase, the hidden menu has the matrix configuration as shown in FIG. 12. In FIGS. 12 and 14, the numeral and arrangement of the direction key are not absolute.

Referring to FIGS. 12 to 14, in case that the received key value is “1”, a signal corresponding to an enter button 51 or a signal corresponding to a selection button is transmitted as a wireless signal. In case that the received key value is “2”, a signal corresponding to once of up button 52 and the enter button 51, or a signal corresponding to the selection button is transmitted as a wireless signal.

In case that the received key value is “3”, a signal corresponding to once of right button 53 and the enter button 51, or a signal corresponding to the selection button is transmitted as a wireless signal. In case that the received key value is “17”, a signal corresponding to once of left button 55, a signal corresponding to twice of the up button 52 and the enter button 51, or a signal corresponding to the selection button is transmitted as a wireless signal.

In the present embodiment, the indexes corresponding to the 25 contents have been described. However, although the numbers of the toys 110 increase, only number of button presses of the up button 52, the down button 53, the left button 54 and the right button 55 increase.

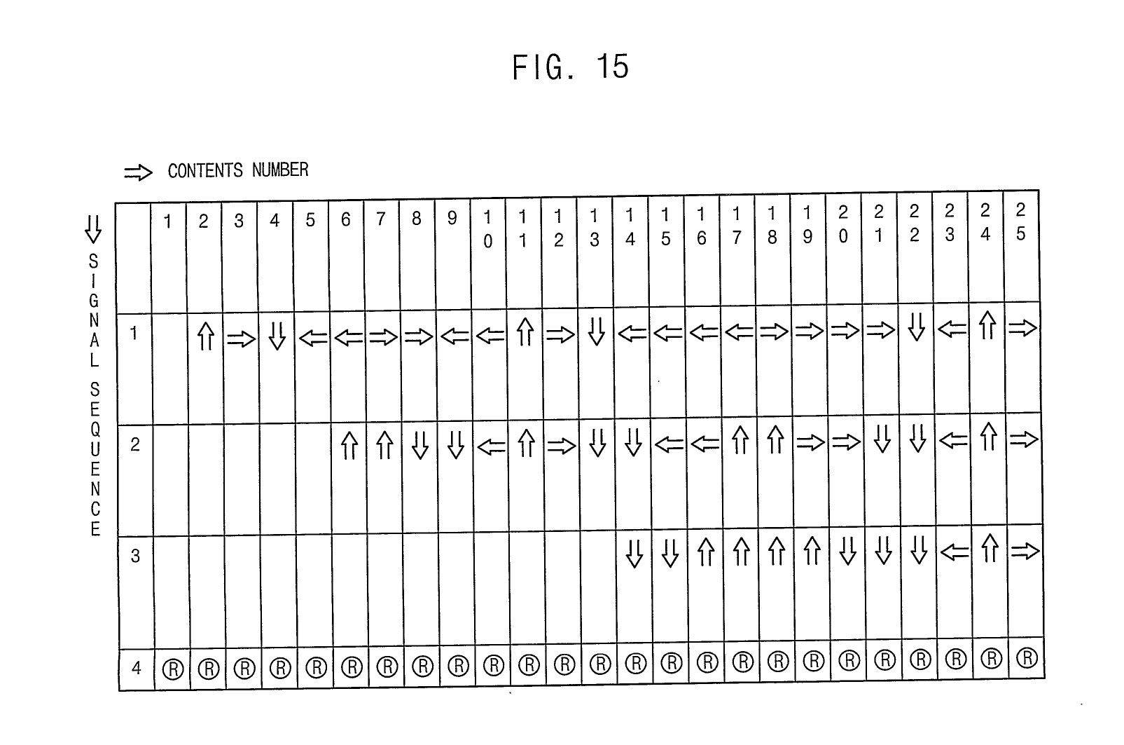

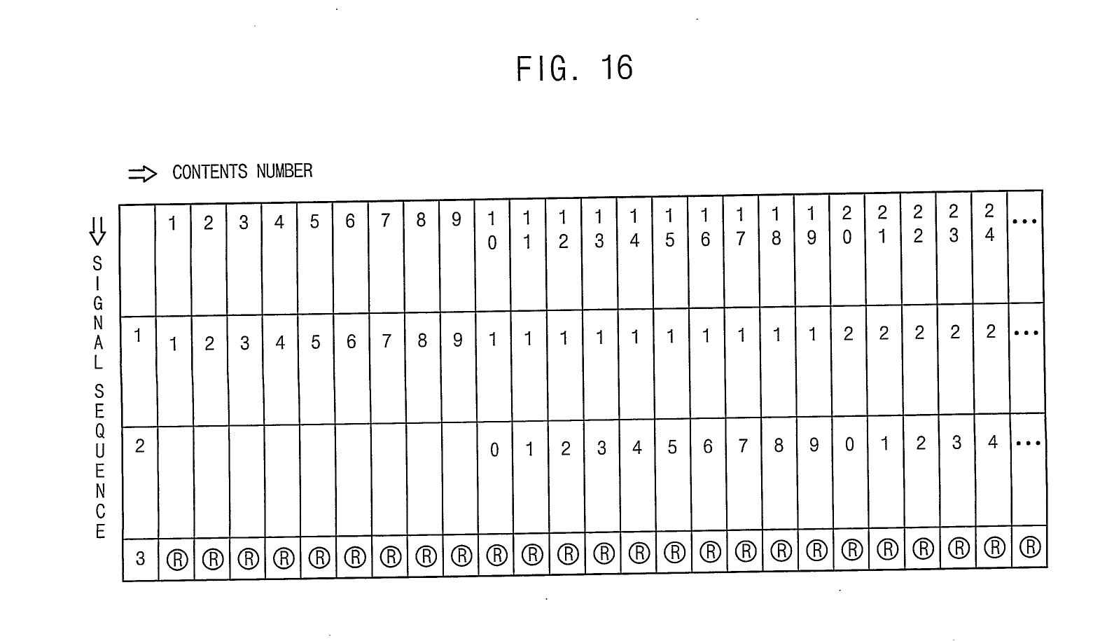

FIGS. 15 and 16 are views illustrating the menu selection of the toy type learning device according to another embodiment of the present invention. Particularly, FIG. 15 is a view illustrating a look-up table according to another embodiment of the present invention, and FIG. 16 is a view illustrating a numeral button and an enter button of a remote controller based on the look-up table in FIG. 15.

Referring to FIGS. 15 and 16, the look-up table according to another embodiment of the present invention includes contents numbers 1, 2, 3, . . . , 24, . . . that are mapped such that the contents number increases along an X-axis (line direction) and a signal sequence that is mapped such that the signal sequence increases along an Y-axis (column direction).

A first contents number (1) corresponding to a first contents request is mapped in a numeral button 61 and an enter button 71 corresponding to the numeral “1”, a second contents number (2) corresponding to a second contents request is mapped in a numeral button 62 and the enter button 71 corresponding to the numeral “2”, and a third contents number (3) corresponding to a third contents request is mapped in a numeral button 63 and the enter button 71 corresponding to the numeral “3”.

As described above, a combination of the numeral buttons and the enter button corresponding to each of the contents numbers is mapped in the look-up table. When the contents number increases, the numbers of the columns (lines) increase, and the numbers of the lines (columns) also increase.

When a predetermined content is selected, the contents request key may be generated by combining the numeral buttons and the enter button based on the look-up table storing a contents request hot key with respect to each of the contents, so that the menu selection method of the toy type learning device may be applied to a remote control device.

In FIGS. 8 and 9, the separated remote control unit setting part 140 has been described in order to control the remote control unit 130, but the remote control unit 130 may be controlled by an internet 500 and a remote control unit setting compact disc 410.

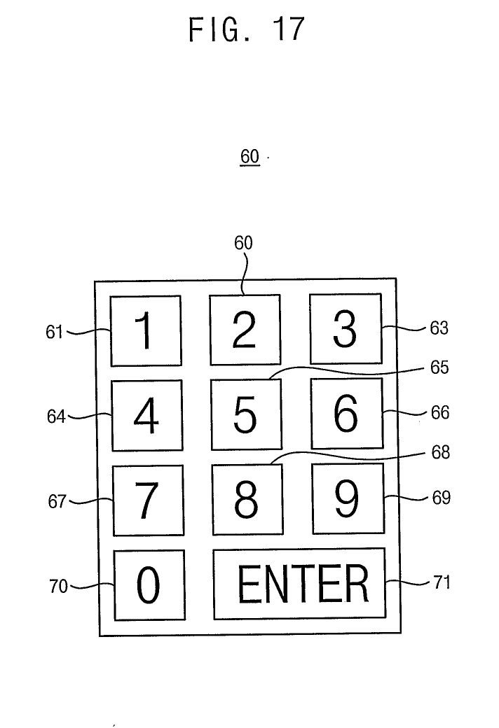

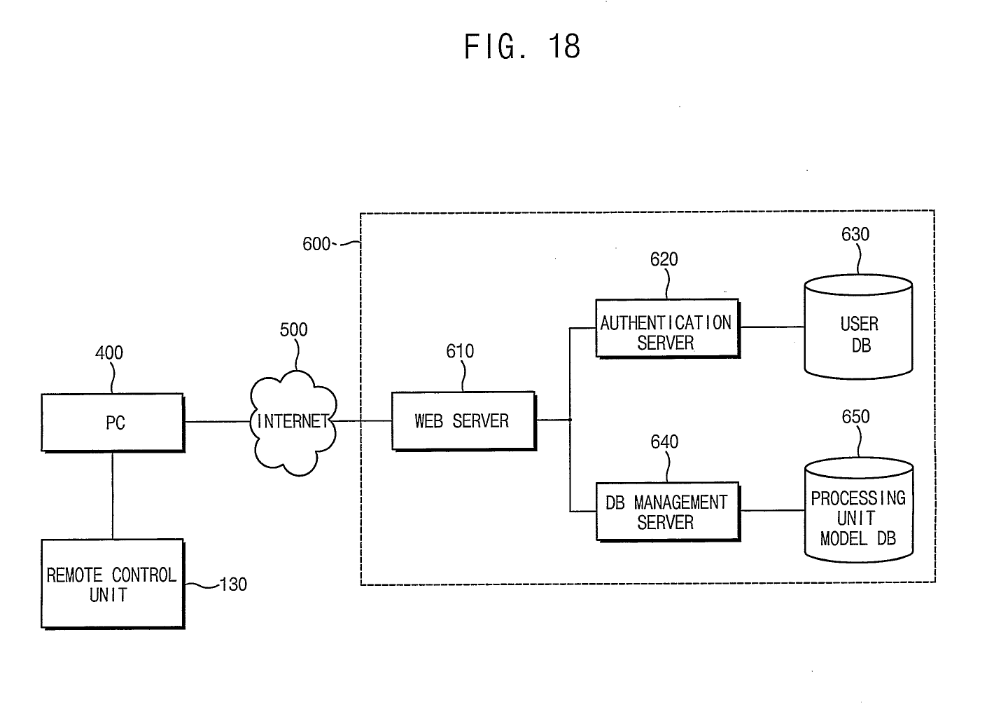

FIG. 17 is a block diagram illustrating a method of controlling the remote control unit with an internet.

As shown in FIG. 17, when a user accesses the provider's site providing the toy type learning device through an internet 500 with his/her personal computer 400, a web server 610 performs an authentication process using an authentication server 620 and a user database 630.

When the user is authenticated, the web server 610 receives a model of the processing unit 200 and extracts a key information value and a speed adjust key value from a database management server 640 and a processing unit model database 650. The extracted key information value and the speed adjust key value are provided to the user's personal computer 400.

The user's personal computer 400 stores the key information value and the speed adjust key value in the memory 134 of the remote control unit 130 through a serial port, a parallel port and a standard Bluetooth manner.

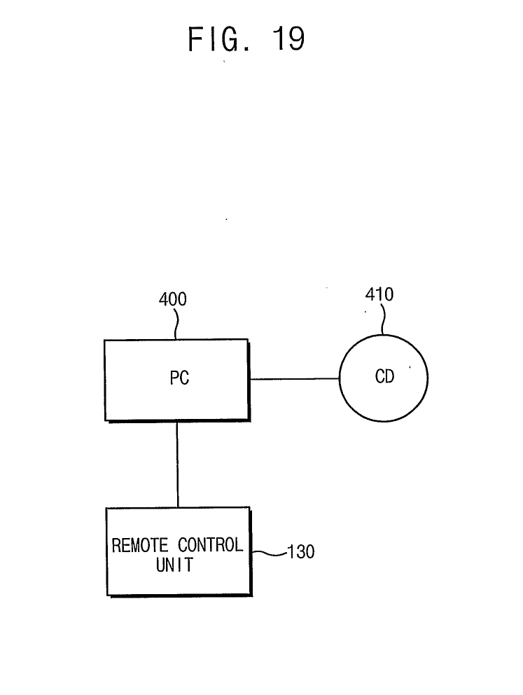

FIG. 18 is a block diagram illustrating a method of controlling the remote control unit with a compact disc.

As shown in FIG. 18, a remote control unit setting compact disc 410 in which software for selecting and inputting the key information value and the speed adjust key value are recorded is loaded in the user's personal computer 400.

The user's personal computer 400 extracts the key information value and the speed adjust key value from the remote control unit setting compact disc 410 in response to a user's operation. The user's personal computer 400 stores the key information value and the speed adjust key value in the memory 134 of the remote control unit 130 through a serial port, a parallel port and a standard Bluetooth manner.

As describe above, the user having the personal computer may control the remote control unit 130 through the remote control unit setting compact disc 410 provided with the toy type learning device or the internet 500 without the remote control unit setting part 140, thereby reducing numbers of parts for the toy type learning device and the manufacturing cost.

### Second Embodiment

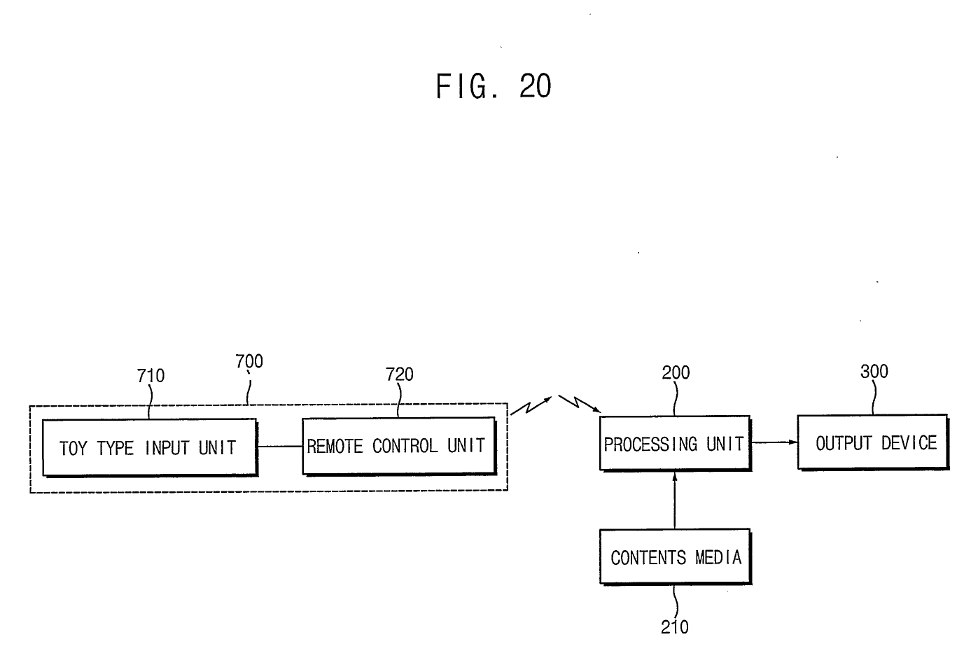

FIG. 19 is a block diagram illustrating a toy type learning device according to a second embodiment of the present invention. FIG. 20 is a view showing a toy type learning device according to the second embodiment of the present invention. In FIGS. 19 and 20, the same reference numerals denote the same elements in FIGS. 1 and 2, and thus any further repetitive descriptions of the same elements will be omitted.

Referring to FIGS. 19 and 20, a toy type learning device according to a second embodiment of the present invention includes a second toy body part 700, a processing unit 200 and an output device 300.

The second toy body part 700 includes a toy 110, a second toy type input unit 710 and a remote control unit 130. The second toy body part 710 outputs a selection signal for selecting contents to a processing unit 200. The remote control unit 130 may be attached to and detached from the second toy body part 710 and controlled by the remote control unit setting part 140.

The second toy type input unit 710 includes a switching device 124 having buttons. When the user pushes the buttons of the second toy type input unit 710, a corresponding contents request signal is transmitted to the processing unit 200 through the remote control unit 130 in the wireless manner. The processing unit 200 extracts the contents corresponding to the pushed buttons from the contents media and outputs the extracted contents through the output device as video/audio information.

The switching part 124 may include various switching devices such as a conventional switching device, a switching device having a sensor in accordance with a kind of toy, etc.

In FIGS. 19 and 20, the remote control unit setting part 140 for the remote control unit 130 is not shown, but the second toy type learning device may include the remote control unit setting part 140 as shown in FIG. 1. The user may also control the remote control unit 130 by using the internet 500 as shown in FIG. 17 or the compact disc as shown in FIG. 18.

### Third Embodiment

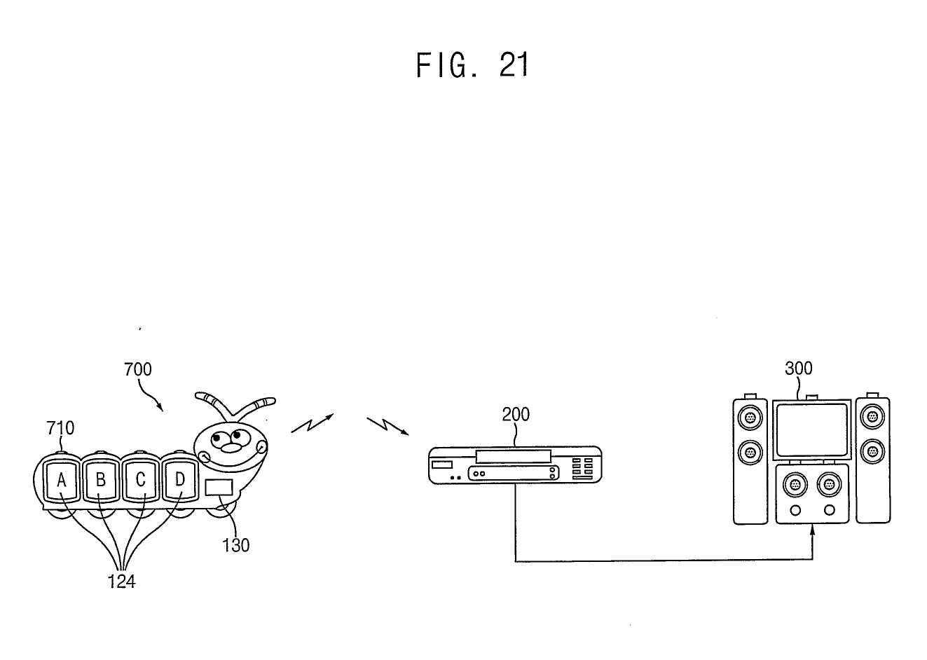

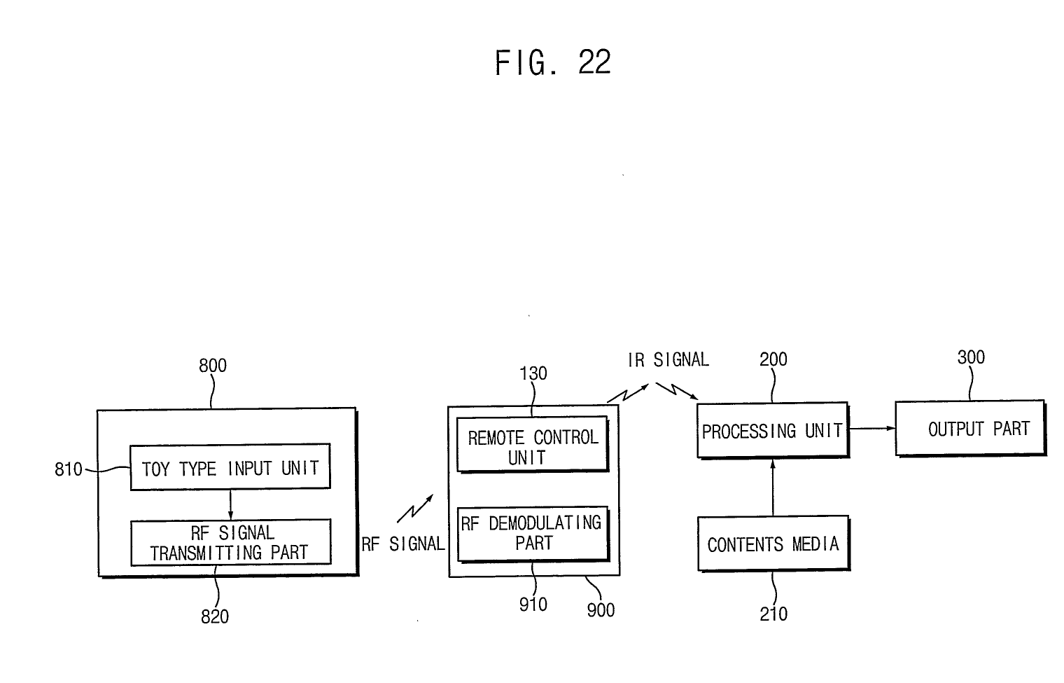

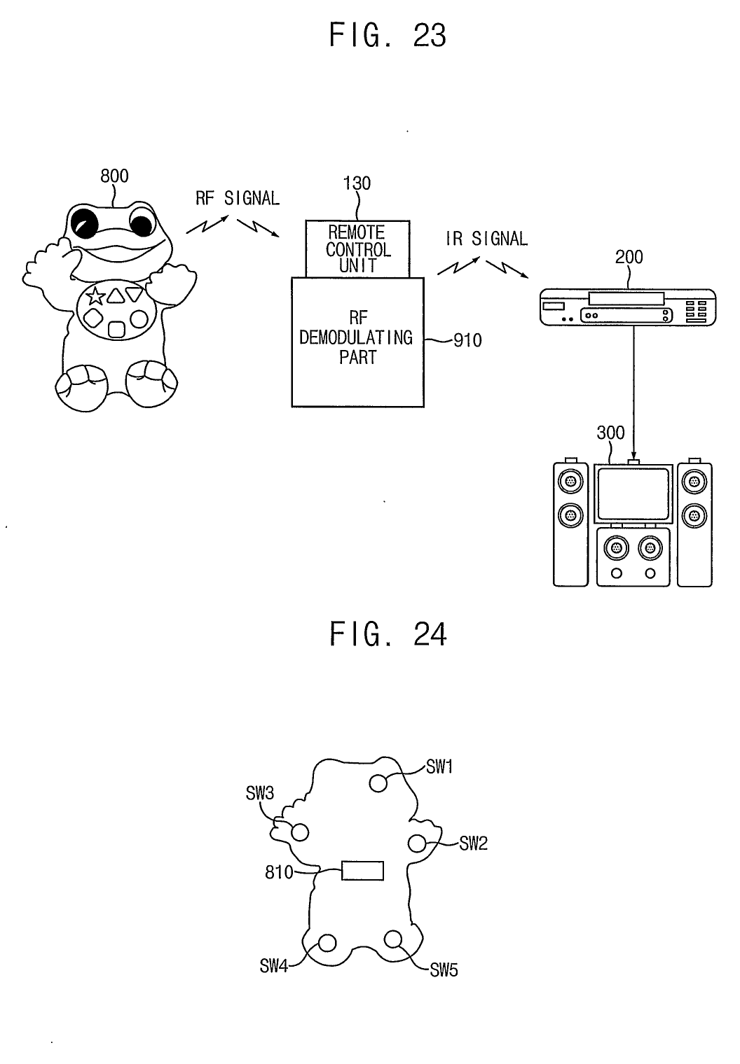

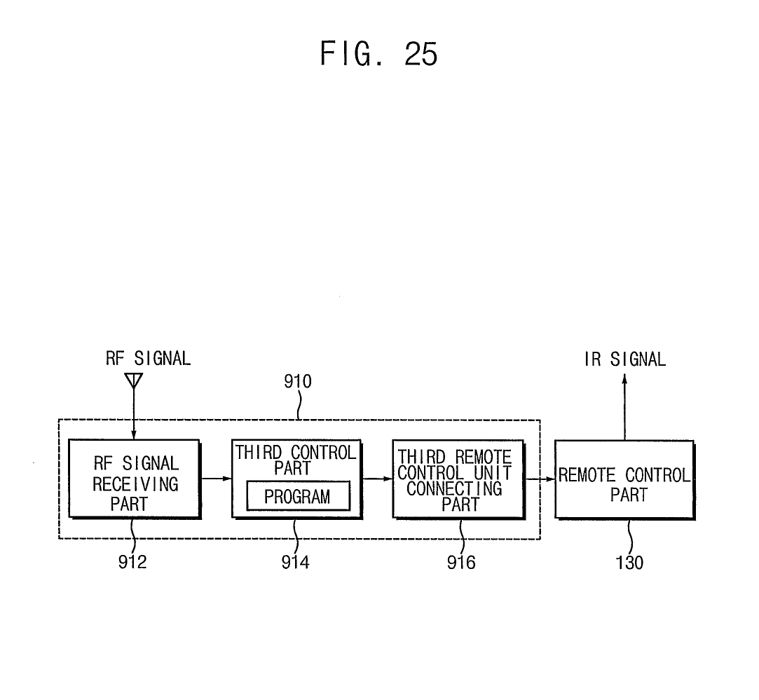

FIG. 21 is a block diagram illustrating a toy type learning device according to a third embodiment of the present invention. FIG. 22 is a view showing a toy type learning device according to the third embodiment of the present invention. FIG. 23 is a view illustrating a toy type input unit shown in FIG. 22. FIG. 24 is a view illustrating a signal relay part shown in FIG. 22. In FIGS. 21 to 24, the same reference numerals denote the same elements in FIG. 1, and thus any further repetitive descriptions of the same elements will be omitted.

Referring to FIGS. 21 and 24, a toy type learning device according to a third embodiment of the present invention includes a third toy body part 800, a signal relay part 900, a processing unit 200 and an output device 300.

The third toy body part 800 includes a third toy type input unit 820 and a radio frequency (RF) signal transmitting part 810 to provide the signal relay part 900 with the contents request signal. A first switch SW1, a second switch SW2, a third switch SW3, a fourth switch SW4 and a fifth switch SW5 for the third toy type input unit 810 are installed at various locations of a doll 800 shown in FIG. 23. The RF signal transmitting part 820 is installed at a center portion of the doll 800. When one of the first, second, third, fourth and fifth switches SW1, SW2, SW3, SW4 and SW5 is pushed by the user, a RF signal corresponding to the pushed switch is provided to the signal relay part 900.

The signal relay part 900 includes a RF demodulating part 910 and a remote control unit 130. The signal relay part 900 demodulates the RF signal and converts the demodulated signal into the contents request signal to transmit the contents request signal to the processing unit 200 as an infrared (IR) signal. The RF demodulating part 910 includes a RF signal receiving part 912, a third control part 914 and a third remote control unit connecting part 916. The remote control unit 130 is attachable to and detachable from the RF demodulating part 910.

In operation time, the RF signal applied to the signal transmitting part 900 is transmitted to the third control part 914 through the RF signal receiving part 912. The transmitted signal is converted into the contents request signal by the third control part 914 and applied to the remote control unit 130 connected to the third remote control unit connecting part 916. The remote control unit 130 requests the contents to the processing unit 200.

Thus, the third toy body part 800 may be freely placed at various locations since the remote control unit 130 is separately inserted into the RF demodulating part 910.

The switching device 124 may include various switching devices such as a conventional switching device, a switching device having a sensor in accordance with a kind of toy, etc.

### INDUSTRIAL APPLICABILITY

According to the present invention, the toy type learning device may provide the user with various stimulates for touch, sight, hearing, etc. to improve education efficiency. Also, since the toy type learning device may provide the user with the video/audio data corresponding to the user's demand, the user may be guided to a proper learning course without a separate assistant for the learning course.

Further, the user such as the infant or the child may easily operate the toy type learning device compared to the conventional education software since the toy type learning device may be operated without using the conventional computer operating system, the keyboard, the mouse and the complicated menu. Moreover, the user such as the infant or the child may easily use the information in the contents media inserted into the processing unit by operating the toy such as the doll in comparison with the convention visual education medium such as the video tape, the digital video disc, etc.

Furthermore, the processing unit is a general player such as the home digital videodisc player for home, and the output part is also a general audio/video device such as a television set, an audio system, etc., thereby reducing the manufacturing cost. When the processing unit is the home digital videodisc player, the user may be provided with high display quality and superior sound.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

1. A toy type learning device comprising:
a toy type input unit for outputting a contents request signal in response to a user's key operation; and
a remote control unit for converting the contents request signal into a wireless signal and outputting the wireless signal to a processing unit having a plurality of contents to request a corresponding content.

2. The toy type learning device of claim 1, wherein the toy type input unit comprises:
a switching device for sensing the user's key operation with respect to a toy and outputting the contents request signal; and
a remote control unit connecting part connected to the remote control unit, for applying the contents request signal to the remote control unit.

3. The toy type learning device of claim 2, wherein the switching device further comprises a toy operation sensing sensor for sensing the user's key operation with respect to the toy and applying the contents request signal to the remote control unit connecting part.

4. The toy type learning device of claim 3, wherein the switching device further comprises a contents request button for applying the contents request signal to the remote control unit connecting part in response to the user's key operation with respect to the toy.

5. The toy type learning device of claim 1, wherein the remote control unit comprises:
an outer connecting part for transmitting a learning key value, a signal interval adjust value or the contents request signal from an exterior;
a memory for storing the learning key value and the signal interval adjust value from the remote control unit through the outer connecting part;
a second control part for operating the contents request signal provided through the outer connecting part, the learning key value and the signal interval adjust value provided from the memory; and
a wireless signal receiving part for converting data provided from the second control part into a wireless signal.

6. The toy type learning device of claim 5, further comprising a remote control unit setting part for controlling the remote control unit.

7. The toy type learning device of claim 6, wherein the remote control unit setting part comprises;
a learning keypad including an up button, a down button, a right button, an enter button or a selection button, for applying a button value corresponding to the user's key operation with respect to the learning keypad to a first control part;
a signal interval adjust keypad including a signal interval increase button and a signal interval decrease button, for applying a button value corresponding to the user's key operation with respect to the signal interval adjust keypad to the first control part;
a wireless signal receiving part for receiving a wireless signal from an external remote controller;
a first control part for combining the button value of the learning keypad and the button value of the wireless signal receiving part to store the combined button value in the memory of the remote control unit, adjusting a signal interval in response to the button value of the signal interval adjust keypad and storing the adjusted signal interval in the memory of the remote control unit; and
a second remote control unit connecting part for being connected to the remote control unit.

8. The toy type learning device of claim 7, wherein the remote control unit setting part further comprises a display part, and the first control part provides the user with at least one of information indicating a storing completion with respect to the memory of the remote control unit, information inducing an key input with respect to the learning keypad, information indicating a signal interval adjust value of the signal interval increase button and the signal interval decrease button of the signal interval adjust keypad.

9. The toy type learning device of claim 1, wherein the contents request key is defined by a combination of a plurality of direction button values and an enter button value or defined by the enter button value and operated based on a look-up table,
wherein the look-up table includes a plurality of contents numbers that are mapped such that the contents numbers increase along a first axis and a signal sequence that is mapped such that the signal sequence increases along a second axis,
wherein a first contents request key is mapped in the enter button, and a remaining contents request key is mapped in at least one direction button among a first direction button, a second direction button, a third direction button and a fourth direction button in a direction where the second axis increases, and the enter button.

10. The toy type learning device of claim 1, wherein the contents request key is defined by a combination of a plurality of numeral button values and an enter button value or defined by the enter button value and operated based on a look-up table,
wherein the look-up table includes a plurality of contents numbers that is mapped such that the contents numbers increase along a first axis and a signal sequence that is mapped such that the signal sequence increases along a second axis,
wherein an N-th (N is natural number) contents number is matched with at least one numeral button and the enter button.

11. A toy type learning device comprising:
a toy type input unit for outputting a contents request signal in response to a user's key operation;
a remote control unit for converting the contents request signal into a wireless signal and outputting the wireless signal;
a processing unit for receiving a contents media and extracting one of a plurality of contents stored in the contents media in response to the wireless signal; and
an output device for outputting the contents provided from the processing unit.

12. The toy type learning device of claim 11, further comprising a remote control unit setting part for applying a signal from a remote controller of the processing unit to the remote control unit and adjusting an interval of the signal so as to control the processing unit.

13. The toy type learning device of claim 12, wherein the remote control unit comprises:
an outer connecting part for transmitting a learning key value, a signal interval adjust value or the contents request signal from an exterior;
a memory for storing the learning key value and the signal interval adjust value from the remote control unit through the outer connecting part;
a second control part for operating the contents request signal provided through the outer connecting part, the learning key value and the signal interval adjust value provided from the memory; and
a wireless signal receiving part for converting data provided from the second control part into a wireless signal.

14. The toy type learning device of claim 11, wherein the learning of a signal from the remote control unit and the interval adjust of the signal are performed by a computer into which a remote control unit setting compact disc is inserted so as to control the processing unit.

15. The toy type learning device of claim 11, wherein a learning of a signal from the remote control unit and an interval adjust of the signal are performed by a computer accessed to an internet site.

16. The toy type learning device of claim 11, further comprising a radio frequency demodulating part for demodulating the radio frequency signal, wherein the contents request signal is transmitted as the radio frequency signal, and the radio frequency demodulating part comprises:
a radio frequency signal receiving part for receiving the radio frequency signal;
a third control part for converting the radio frequency signal into the contents request signal; and
a third remote control unit connecting part for transmitting the converted contents request signal into the remote control unit.

17. In a method of controlling a toy type learning device outputting contents corresponding to a user's key operation through an output device, the method comprising:
sensing the user's key operation with respect to the toy to output a contents request signal;
converting the contents request signal into a wireless signal to output the wireless signal; and
extracting one of the contents stored in a contents media in response to the wireless signal to output the extracted contents.

18. The method of claim 17, further comprising applying a signal outputted from a remote controller of a processing unit and adjusting an interval between the signal and an adjacent signal so as to control the processing unit, and the processing unit is controlled by the wireless signal.

19. The method of claim 18, wherein the applying of the signal comprises:
checking whether or not a user pushes a key when an external remote control unit is inserted;
checking whether or not a key signal from an external remote controller is inputted when the user pushes the key; and
storing the pushed key value and the key signal value when the key signal from the external remote controller is inputted.

20. The method of claim 19, further comprising displaying at least one of information indicating a storing completion with respect to the memory of the remote control unit and information inducing a key input with respect to the learning keypad when the key signal from the external remote controller is inputted.

21. The method of claim 18, wherein the adjusting of the signal interval comprises:
checking whether or not a user pushes a signal interval adjust key when an external remote control unit is inserted; and
storing a speed adjust key value when the user pushes the signal interval adjust key.

22. The method of claim 21, further comprising displaying an adjusted signal interval value when the user pushes the signal interval adjust key.

23. The method of claim 17, wherein the converting of the wireless signal comprises:
extracting the stored key value and the signal interval value in response to the contents request signal;
generating a signal corresponding to a look-up table based on the contents request signal; and
transmitting the generating signal in a wireless manner.
